(19) United States
(12) Patent Application Publication
(10) Pub. No.: US 2006/0272816 A1
(43) Pub. Date: Dec. 7, 2006

(54) Proppants Useful for Prevention of Scale Deposition

(76) Inventors: Dean M. Willberg, Moscow (RU); Erik Nelson, Houston, TX (US); Wayne Frenier, Tulsa, OK (US)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 11/419,596

(22) Filed: May 22, 2006

Related U.S. Application Data
(60) Provisional application No. 60/686,960, filed on Jun. 2, 2005.

(51) Int. Cl. E21B 43/267; C09K 8/80

(52) U.S. Cl. 166/279; 166/280.2; 166/300; 166/308.5; 507/922; 507/924; 166/278; 507/925; 507/211; 507/224; 507/225; 507/269

(57) ABSTRACT

Proppants for treating subterranean which are scale resistant as well as fluids containing and methods of using such proppants. The proppant materials are less susceptible to fouling by residual materials in the fracturing or gravel pack fluid and hence may have improved clean-up compared with conventional materials. Long-term scale deposition during well production may also be improved. Proppant materials according to the invention are typically used in conjunction with carrier fluids or formation treatment fluids, such as fracturing treatments, for placement in the formation or wellbore penetrating the formation.

### RELATED APPLICATION DATA

This patent application is a non-provisional application based upon provisional application Ser. No. 60/686,960, filed Jun. 2, 2005, and claims the benefit of the filing date thereof.

### BACKGROUND OF THE INVENTION

This invention relates to improved materials for treating subterranean formations using solid particles and other solid materials, and in particular, proppants which are scale resistant as well as fluids containing and methods of using such

Hydrocarbon producing subterranean formations penetrated by well bores are often treated by forming gravel packs of solid particles adjacent to the subterranean formation and/or fracturing the subterranean formation and depositing proppant particle packs in the fractures. In fracturing operations, solid particles, referred to in the art as proppant or gravel, are suspended in water or a viscous fluid at the surface and carried to a fracture in the well bore in which it is to be placed at a designed proppant concentration and pump rate. As the proppant is being placed in the well bore, the carrier fluid is either returned to the surface via the washpipe or leaked off into the formation. The propped fracture produced functions to keep the fracture open as well as a filter to separate formation sand and solid fines from produced fluids while permitting the produced fluids to flow into and through the well bore.

A problem often experienced in subterranean formations penetrated by well bores is inorganic scale. The scale often comprises such compounds as barium sulfate, calcium carbonate, and the like, which deposit in well bores or completions, presenting production problems during lifetime of a field. While remediation of scale using specialized treatment is available, this approach is often prohibitive, such as in cases of sub-sea completions, or where shut down results in unacceptable loss of revenue for the producer, or even when the placement of remedial chemicals is difficult (i.e. extended reach wells, multi-laterals, or in hydraulic fractures).

The need exists for improved proppant materials for treating subterranean formations which provide prevention of long-term scale deposition after treatment, and materials that can achieve this would be highly desirable.

### SUMMARY OF THE INVENTION

Disclosed are improved materials for treating subterranean formations using solid particles and other solid materials, and in particular, proppants which are scale resistant as well as fluids containing and methods of using such. The proppant materials are less susceptible to fouling by residual materials in the fracturing or gravel pack fluid and hence may have improved clean-up compared with conventional materials. Long-term scale deposition during well production may also be improved. Proppant materials according to the invention are typically used in conjunction with carrier fluids or formation treatment fluids, commonly known in the art, for placement in the formation or wellbore penetrating the formation.

Proppants may be formed of a substrate coated with a material, such as an amorphous material, that resists the deposition of scale forming minerals and/or compounds. The proppant may also be formed substantially of a material, such as an amorphous material, that resists the deposition of scale. The proppant may be of any suitable shape, including by non-limiting example spherical, rod, oblong, fibrous, and the like.

The invention also includes methods of fracturing a subterranean formation, where the methods include injecting a hydraulic fluid into a subterranean formation at a rate and pressure sufficient to open a fracture, and injecting into the fracture a fluid containing a proppant material formed of substrate material and a scale resistant coating. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. In addition to fracturing, the fluids and proppants of the invention may be used in gravel packing operations.

The invention also includes fluids incorporating the proppants. Fluids commonly contain an aqueous medium which may be based upon produced water, water, seawater, and/or brine. Fluids useful in the invention may also include a viscosifying agent for suspending and transporting the proppant, where the viscosifying agent may be a polymer that is either crosslinked or linear, a viscoelastic surfactant, clay (Bentonite and attapulgite), or any combination thereof. Some nonlimiting examples of suitable polymers include guar gums, high-molecular weight polysaccharides composed of mannose and galactose sugars, or guar derivatives such as hydropropyl guar (HPG), carboxymethyl guar (CMG), and carboxymethylhydropropyl guar (CMHPG). Cellulose derivatives such as hydroxyethylcellulose (HEC) or hydroxypropylcellulose (HPC) and carboxymethylhydroxyethylcellulose (CMHEC) may also be used in either crosslinked form, or without crosslinker in linear form. Xanthan, diutan, and scleroglucan, three biopolymers, have been shown to be useful as viscosifying agents. Polyacrylamide and polyacrylate polymers and copolymers are used typically for high-temperature applications. Nonlimiting examples of suitable viscoelastic surfactants useful for viscosifying some fluids include cationic surfactants, anionic surfactants, zwitterionic surfactants, amphoteric surfactants, nonionic surfactants, and combinations thereof.

### DETAILED DESCRIPTION

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components others than the ones already cited. In the summary of the invention and this detailed description, each numerical value should be read once as modified by the term “about” (unless already expressly so modified), and then read again as not so modified unless otherwise indicated in context.

The invention relates to improved materials for treating subterranean formations using solid particles and other solid materials. In particular, the invention discloses improved particulate or proppant materials, fluids containing such particles, and methods of using such for treating subterranean formations. The proppant materials are less susceptible to fouling by residual materials in the fracturing or gravel pack fluid and hence will tend to clean-up better than conventional materials. Also, prevention of long-term scale deposition during well production may be improved. Proppant materials according to the invention are typically used in conjunction with carrier fluids or formation treatment fluids, commonly known in the art, for placement in the formation or wellbore penetrating the formation. As used herein the term “proppant” means any particulate, proppant, gravel materials, and the like, which may be placed in a formation fracture. The concept of scale resistance, or resistance to deposition of scale, means 1) a material upon which it is difficult to form (or crystallize) a scale, 2) a material which modifies the wetting and fluid mechanical behavior in its immediate environment that reduces the tendency of scales to form, or 3) a material which effectively repulses fracture fluid residue.

Some proppants according to the invention are a substrate material coated with a material, such as an amorphous material, that resists the deposition of scale forming minerals and/or compounds. The proppant may also be formed substantially of a material, such as an amorphous material, that resists the deposition of scale. The proppant may be of any suitable shape, including by non-limiting example spherical, rod, oblong, fibrous, and the like. The proppant may also be hollow or porous so that it may have a lower or specific overall specific gravity. Any suitable coating or material which resists scale forming deposits may be used.

When a coating is used to form the proppant, the coating may be applied upon any appropriate substrate material, including, but not necessarily limited to, ceramic, metallic, polymeric, composite, glass, silicate, and the like. In some embodiments of the invention, the proppant is composed of a substrate coated with a metallic glass coating, or the proppant is composed of a metallic glass. Any suitable means to apply the coating may be used, including such techniques as vapor or plasma deposition, spray coating, thermal coating, ball mill coating, and the like.

The substrate material may be inert to components in the subterranean formation, e.g., well treatment fluids, and be able to withstand the conditions, e.g., temperature and pressure, in the well. The substrate materials, e.g., minerals or combinations of minerals and fibers, of different dimensions and/or materials may be employed together. The substrate material is preferably mono crystalline in nature, or to be fabricated in such a way as to be more abrasion resistant, and thus enhance the ability of the proppant to withstand pneumatic conveying. It may be desirable in some cases that the dimensions and amount of substrate material, as well as the type and amount of any coating, be selected so that the substrate material remain within the coating of the proppant rather than being loosely mixed with proppant particles. The containment of substrate materials prevents loose particles from clogging parts, e.g., screens, of an oil or gas well. Moreover, the attachment prevents loose particles from decreasing permeability in the oil or gas well.

The substrate material may be at least one of silica a (i.e. quartz sand), alumina, fumed carbon, carbon black, graphite, mica, silicate, calcium silicate, calcined or uncalcined kaolin, talc, zirconia, boron, aluminosilicate ceramics and glass. Microcrystalline silica is especially preferred. A typical silicate for use as filler is NEPHELINE SYENITE, a whole grain sodium potassium alumina silicate available from Unimin Corporation, New Canaan, Conn.

The substrate material may range in size from about 2 to about 60 μm. Typically, the materials have a d 50 of about 4 to about 45 μm, preferably about 4 to about 6 μm. The parameter d 50 is defined as the diameter for which 50% of the weight of particles have the specified particle diameter.

When fibers are incorporated in proppants according to the invention, they may be any of various kinds of commercially available short fibers. Such fibers include at least one member selected from the group consisting of milled glass fibers, milled ceramic fibers, milled carbon fibers, natural fibers, and synthetic fibers, e.g., crosslinked novolac fibers, having a softening point above typical starting temperature for blending with resin, e.g., at least about 200° F., so as to not degrade, soften or agglomerate.

The typical glasses for fibers include E-glass, S-glass, and AR-glass. E-glass is a commercially available grade of glass fibers typically employed in electrical uses. S-glass is used for its strength. AR-glass is used for its alkali resistance. The carbon fibers are of graphitized carbon. The ceramic fibers are typically alumina, porcelain, or other vitreous material.

Fiber lengths range from about 6 microns to about 3200 microns (about ⅛ inch). Preferred fiber lengths range from about 10 microns to about 1600 microns. More preferred fiber lengths range from about 10 microns to about 800 microns. A typical fiber length range is about 25 microns to about 2000 microns. Preferably, the fibers are shorter than the greatest length of the substrate. Suitable, commercially available fibers include milled glass fiber having lengths of about 500 microns to about 2500 microns; milled ceramic fibers 25 microns long; milled carbon fibers 250 to 350 microns long, and KEVLAR aramid fibers 12 microns long. Fiber diameter (or, for fibers of non-circular cross-section, a hypothetical dimension equal to the diameter of a hypothetical circle having an area equal to the cross-sectional area of the fiber) range from about 1 to about 20 microns. Length to aspect ratio (length to diameter ratio) may range from about 5 to about 175. The fiber may have a round, oval, square, rectangular or other appropriate cross-section. One source of the fibers of rectangular cross-section may be chopped sheet material. Such chopped sheet material would have a length and a rectangular cross-section. The rectangular cross-section has a pair of shorter sides and a pair of relatively longer sides. The ratio of lengths of the shorter side to the longer side is typically about 1:2-10. The fibers may be straight, crimped, curled or combinations thereof.

Metallic glasses are particularly useful in preparing some proppants used in some embodiments of the invention. While the embodiments of the invention are not bound to any particularly to any theories or mechanisms of operation, in the case of metallic glass materials, perhaps due to amorphous characteristics at a molecular level, no crystal structure, no grain boundaries, or no dislocations, metallic glasses have very unique mechanical and chemical properties. These characteristics may impart corrosion resistance, when compared with crystalline analogs, and often exhibit excellent erosion and wear characteristics. Also, the amorphous metallic glass surface may not offer crystal nucleation sites for the initiation and growth of scale forming minerals or compounds. In addition to their inherent chemical properties and resistance to corrosion, certain metallic glasses demonstrate exceptional mechanical properties, such as resistance to wear and erosion that would also be beneficial for application in well completions.

Some metallic glass materials used in some embodiments of the invention are known as amorphous metals. Such metallic glass materials may be structural amorphous metals (SAM) that can be primarily defined as bulk, structural metallic materials whose microstructures, unlike that of conventional metals, are non-crystalline, amorphous, or “glassy” in the solid state. Also included in the primary definition of SAM are metallic materials whose crystalline microstructures are formed from an amorphous or glassy condition or are synthesized/derived from an amorphous metal and exhibit combinations of crystalline and amorphous micro-architectured features. These metallic glass materials may differ from traditional metals in that they have a non-crystalline structure and possess unique physical and magnetic properties that combine strength and hardness with flexibility and toughness. The metallic glass may be an alloy or a pure metal, with a disordered atomic-scale structure. In contrast to most metals, which are crystalline and therefore have a highly ordered arrangement of atoms, structural amorphous metals are non-crystalline. Materials in which such a disordered structure is produced directly from the liquid state during cooling are called “glasses”, and so structural amorphous metals are commonly referred to as “metallic glasses” or “glassy metals”. There are several other ways in which structural amorphous metals can be produced, including physical vapor deposition, solid-state reaction, ion irradiation, and mechanical alloying. A useful property of structural amorphous metals is that they soften and flow upon heating. This allows for processing, such as by injection molding, in much the same way as polymers. Some nonlimiting example of materials used to form the structural amorphous metals include boron, graphite, iron, selenium, silicon, gold, tungsten, titanium, any mixtures thereof, and the like.

In some embodiments, the proppant may be fabricated substantially from metallic glass. Also, metallic glasses may be applied as a coating to other substrate materials. When applied as a coating, the metallic glass may be applied to using a plasma spray process, for example.

In other embodiments of the invention, the proppants use other materials to prevent scale deposits forming in proppant or gravel packs. For example, chemically resistant materials such as fluoropolymers (i.e. Teflon®, Kynar®) or other chemical-resistant fluorinated organic materials, may be used to coat substrates.

Proppants according to the invention may be used as part of hydraulic fracturing operations, or as a packing filtration material in gravel packing behind screen. The proppants according to the invention may give exceptional corrosion resistance, as well as resisting fouling by scale forming minerals. The scale resistant materials used to coated proppants according to the invention may also be effective to prevent scale deposition on down hole tools, valves, screens, and the like.

Some embodiments of the invention are methods of fracturing a subterranean formation, the methods including injecting a hydraulic fluid into a subterranean formation at a rate and pressure sufficient to open a fracture therein, and injecting into the fracture a fluid containing a proppant material formed of substrate material and a scale resistant coating upon the substrate material. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein, the disclosures of which are incorporated herein by reference thereto.

In most cases, a hydraulic fracturing consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, proppants are added to the fluid to form a slurry that is pumped into the fracture to prevent it from closing when the pumping pressure is released. The proppant suspension and transport ability of the treatment base fluid traditionally depends on the type of viscosifying agent added.

When used in fracturing operations, the proppant may be applied as the sole proppant in a 100% proppant pack (in the hydraulic fracture) or as a part replacement of existing commercial available ceramic and/or sand-based proppants, resin-coated and/or uncoated, or as blends between those, e.g., composite particles are 10 to 50 weight % of the proppant injected into the well. The proppants may also be employed as the sole media in a 100% filtration pack or blended with other filtration media. Also, the proppant may be used as “blends” where the coated proppants are thoroughly and intimately mixed with conventional or other proppants, or the proppant may be used as “tail-ins” where the coated proppant is “tailed in” at the end of a treatment (to protect the most susceptible near-wellbore region from scale), or even, the proppant may be used in specific placement techniques, where the proppant may be layered in a fracture by depositional or slickwater methods.

When proppants according to the invention are used for gravel packing operations, the proppant particles would be provided in the standard sizes known for gravel used in gravel packs. The gravel packs may typically comprise from about 5 to about 50 weight percent of the proppant.

In addition to fracturing and gravel packing operations, the proppants of the invention may be used to modify the permeability of subterranean formations, sand control, placement of a chemical plug to isolate zones or to assist an isolating operation, and the like.

Proppants according to the invention may also be used in conjunction with other commonly used proppant materials, which are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of composition, preferably from about 0.05 to about 2 kilograms of proppant added per liter of composition, more preferably from about 0.07 to about 2 kilograms of proppant added per liter of composition, and even more preferably from about 0.07 to about 1.5 kilograms of proppant added per liter of composition. Also, any of the proppant particles can further be coated with a resin to potentially improve the strength, clustering ability, and flow back properties of the proppant.

Fluids incorporating the proppants and used according to the invention may comprise an aqueous medium which is based upon, at least in part, produced water. The aqueous medium may also contain some water, seawater, or brine. In those embodiments of the invention where the aqueous medium is a brine, the brine is water comprising an inorganic salt or organic salt. Preferred inorganic salts include alkali metal halides, more preferably potassium chloride. The brine phase may also comprise an organic salt more preferably sodium or potassium formate. Preferred inorganic divalent salts include calcium halides, more preferably calcium chloride or calcium bromide. Sodium bromide, potassium bromide, or cesium bromide may also be used. The salt is chosen for compatibility reasons i.e. where the reservoir drilling fluid used a particular brine phase and the completion/clean up fluid brine phase is chosen to have the same brine phase.

Fluids useful in the invention include a viscosifying agent for suspending and transporting the proppant, where the viscosifying agent may be a polymer that is either crosslinked or linear, a viscoelastic surfactant, clay (Bentonite and attapulgite), or any combination thereof. For hydraulic fracturing or gravel packing, or a combination of the two, aqueous fluids for pads or for forming slurries are generally viscosified. Viscoelastic surfactants (“VES's”) form appropriately sized and shaped micelles that add viscosity to aqueous fluids. Small amounts of polymers may be used to increase the viscosity or for purposes, for example as friction reducers. Breakers may also be used with VES's.

Examples of suitable polymers for use as viscosifying agents in the fluids, and/or used according to some embodiments of invention include, but are not necessarily limited to, guar gums, high-molecular weight polysaccharides composed of mannose and galactose sugars, or guar derivatives such as hydropropyl guar (HPG), carboxymethyl guar (CMG), carboxymethylhydropropyl guar (CMHPG). Cellulose derivatives such as hydroxyethylcellulose (HEC) or hydroxypropylcellulose (HPC) and carboxymethylhydroxyethylcellulose (CMHEC) may also be used in either crosslinked form, or without crosslinker in linear form. Xanthan, diutan, and scleroglucan, three biopolymers, have been shown to be useful as viscosifying agents. Polyacrylamide and polyacrylate polymers and copolymers are used typically for high-temperature applications. Of these viscosifying agents, guar, hydroxypropyl guar and carboxymethlyhydroxyethyl guar are commonly used. In many instances, the polymeric viscosifying agent is crosslinked with a suitable crosslinker. Suitable crosslinkers for the polymeric viscosifying agents can comprise a chemical compound containing an ion such as, but not necessarily limited to, chromium, iron, boron, titanium, and zirconium. The borate ion is a particularly suitable crosslinking agent. When polymers are incorporated into fluids used in embodiments of the invention, the amount of polymer may range from about 0.01% to about 1.00%, and preferably about 0.10% to about 0.40% by weight of total fluid weight.

A viscoelastic surfactant (VES) may be used in fluids of some embodiments of the invention, as a viscosifying agent. The VES may be selected from the group consisting of cationic, anionic, zwitterionic, amphoteric, nonionic and combinations thereof, such as those cited in U.S. Pat. No. 6,435,277 (Qu et al.) and U.S. Pat. No. 6,703,352 (Dahayanake et al.), each of which are incorporated herein by reference. The surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

When a VES is incorporated into fluids used in embodiments of the invention, the VES can range from about 0.2% to about 15% by weight of total weight of fluid, preferably from about 0.5% to about 15% by weight of total weight of fluid, more preferably from about 0.5% to about 15% by weight of total weight of fluid. A particularly useful VES is Erucyl bis-(2-Hydroxyethyl) Methyl Ammonium Chloride.

The fluids used according to the invention may further comprise one or more members from the group of organic acids, organic acid salts, and inorganic salts. Mixtures of the above members are specifically contemplated as falling within the scope of the invention. This member will typically be present in only a minor amount (e.g. less than about 30% by weight of the liquid phase).

The organic acid is typically a sulfonic acid or a carboxylic acid, and the anionic counter-ion of the organic acid salts is typically a sulfonate or carboxylate. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred as salicylate, phthalate, p-toluene sulfonate, hydroxynaphthalene carboxylates, e.g. 5-hydroxy-1-napthoic acid, 6-hydroxy-1-napthoic acid, 7-hydroxy-1-napthoic acid, 1-hydroxy-2-naphthoic acid, preferably 3-hydroxy-2-naphthoic acid, 5-hydroxy-2-naphthoic acid, 7-hydroxy-2-napthoic acid, and 1,3-dihydroxy-2-naphthoic acid and 3,4-dichlorobenzoate.

The inorganic salts that are particularly suitable include, but are not limited to, water-soluble potassium, sodium, and ammonium salts, such as potassium chloride and ammonium chloride. Additionally, calcium chloride, calcium bromide and zinc halide salts may also be used. The inorganic salts may aid in the development of increased viscosity that is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salt unless fluid density becomes an important consideration, at which point, heavier inorganic salts may be used.

Friction reducers may also be incorporated as viscosifying agents into fluids useful according to the invention. Any friction reducer may be used. Also, polymers such as polyacrylamide, polyisobutyl methacrylate, polymethyl methacrylate and polyisobutylene as well as water-soluble friction reducers such as guar gum, polyacrylamide and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks “FLO 1003, 1004, 1005 & 1008” have also been found to be effective. These polymeric species added as friction reducers or viscosity index improvers may also act as excellent fluid loss additives reducing or even eliminating the need for conventional fluid loss additives.

Breakers may also be used in the invention. The purpose of this component is to “break” or diminish the viscosity of the fluid so that this fluid is more easily recovered from the fracture during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily eliminate the borate/polymer bonds. At a high pH above 8, the borate ion exists and is available to crosslink and cause gelling. At lower pH, the borate is tied up by hydrogen and is not available for crosslinking, thus gelation caused by borate ion is reversible. Citric acid may also be used as a breaker, as described in U.S. published patent application 2002/0004464 (Nelson et al.), published on filed on Jan. 10, 2002, which is incorporated herein by reference.

Methods and fluid of the invention may further be used with contain other additives and chemicals that are known to be commonly used in oilfield applications by those skilled in the art. These include, but are not necessarily limited to, materials such as surfactants in addition to those mentioned hereinabove, breaker aids, oxygen scavengers, alcohols, scale inhibitors, corrosion inhibitors, fluid-loss additives, bactericides, and the like. Also, they may include oxidizers such as ammonium persulfate and sodium bromate, and biocides such as 2,2-dibromo-3-nitrilopropionamine. Also, anti-scale technologies such as ScaleFRAC, ScalePROP, and various scale inhibitor chemical treatments may be used.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of fracturing a subterranean formation, comprising injecting a hydraulic fluid into a subterranean formation at a rate and pressure sufficient to open a fracture therein, and injecting into the fracture a fluid containing a proppant material comprising a substrate material and a scale resistant material coating the substrate material.

2. The method of claim 1, wherein the scale resistant material is selected from the group consisting of metallic glass, fluoropolymer, ceramic, or silicate.

3. The method of claim 1, wherein the fluid comprises a viscosifying agent.

4. The method of claim 3, wherein the viscosifying agent is a viscoelastic surfactant.

5. The method of claim 3, wherein the viscosifying agent is a polymer.

6. The method of claim 3, wherein the fluid further comprising a crosslinker.

7. The method of claim 4, wherein the viscoelastic surfactant is selected from the group consisting of cationic, anionic, zwitterionic, amphoteric, nonionic and combinations thereof.

8. The method of claim 5, wherein the polymer is selected from the group consisting of hydropropyl guar (HPG), carboxymethyl guar (CMG), carboxymethylhydropropyl guar (CMHPG), hydroxyethylcellulose (HEC), hydroxypropylcellulose (HPC), carboxymethylhydroxyethylcellulose (CMHEC), xanthan, diutan, scleroglucan, polyacrylamide polymers, polyacrylate polymers, or any mixtures thereof.

9. A subterranean treatment fluid comprising a viscosifying agent and a proppant, wherein the proppant comprises a substrate material and a scale resistant material coating the substrate material.

10. The fluid of claim 9, wherein the scale resistant material is selected from the group consisting of metallic glass, fluoropolymer, ceramic, or silicate.

11. The fluid of claim 9, wherein the viscosifying agent is a viscoelastic surfactant.

12. The fluid of claim 11, wherein the viscoelastic surfactant is selected from the group consisting of cationic, anionic, zwitterionic, amphoteric, nonionic and combinations thereof.

13. The fluid of claim 9, wherein the viscosifying agent is a polymer.

14. The method of claim 13, wherein the polymer is selected from the group consisting of hydropropyl guar (HPG), carboxymethyl guar (CMG), carboxymethylhydropropyl guar (CMHPG), hydroxyethylcellulose (HEC), hydroxypropylcellulose (HPC), carboxymethylhydroxyethylcellulose (CMHEC), xanthan, diutan, scleroglucan, polyacrylamide polymers, polyacrylate polymers, or any mixtures thereof.

15. The fluid of claim 9, wherein the fluid further comprising a crosslinker.

16. A proppant material comprising a substrate material and a scale resistant material coating the substrate material.

17. The proppant material according to claim 16, wherein the scale resistant material is selected from the group consisting of metallic glass, fluoropolymer, ceramic, or silicate.

18. The proppant material according to claim 16, for which the shape is rod, oblong, fibrous, or mixtures thereof.

19. The proppant material according to claim 16, for which the shape is spherical.

20. A subterranean formation fracturing fluid comprising the proppant material according to claim 16.

21. A subterranean formation gravel packing fluid comprising the proppant material according to claim 16.
